(19) United States
(12) Patent Application Publication
(10) Pub. No.: US 2026/0059394 A1
(43) Pub. Date: Feb. 26, 2026

(54) Adaptive Autonomous Fast Return to New Radio

(71) Applicant: Apple Inc., Cupertino, CA (US)

(72) Inventors: Ruirui ZONG, Beijing (CN); Ang LI, Beijing (CN); Ramji GRANDHI, San Diego, CA (US); Rangakrishna NALLANDIGAL, Santa Clara, CA (US); Tao ZHU, Beijing (CN); Yaoqi YAN, Beijing (CN)

(21) Appl. No.: 19/102,627

(22) PCT Filed: Aug. 10, 2023
(86) PCT No.: PCT/US2023/029924

§ 371 Date: Feb. 10, 2025

Related U.S. Application Data
(60) Provisional application No. 63/370,946, filed on Aug. 10, 2022.

(51) Int. Cl. H04W 36/00; H04W 36/30

(52) U.S. Cl. CPC H04W 36/0022; H04W 36/30

(57) ABSTRACT

A user equipment (UE) configured to connect to a first network, perform a voice call fallback operation comprising disconnecting from the first network and performing a voice call on a second network, initiate a data service comprising uplink of data via the second network during the voice call, monitor data performance parameters associated with the second network and when the voice call is completed and there remains data to be uplinked for the data service, determine whether to remain on the second network or to return to the first network based at least on the data performance parameters.

### PRIORITY/INCORPORATION BY REFERENCE

This application claims priority to U.S. Provisional Application Ser. No. 63/370,946 filed on Aug. 10, 2022, and entitled “Adaptive Autonomous Fast Return to New Radio,” the entirety of which is incorporated herein by reference.

### BACKGROUND

A user equipment (UE) connected to an NR network may initiate an IP Multimedia Subsystem (IMS) voice call. The UE may then fall back to LTE to continue with the call. User data can be triggered and exchanged during the call simultaneously with the ongoing voice call. When the call ends in LTE, the UE will attempt to return to NR as quickly as possible. The UE will trigger blind autonomous fast return to NR (FR2NR) if the network fails to redirect the UE back to NR in a specified time window even if a parallel data service upload is ongoing. Autonomous FR2NR leads to local data connection release. Data transmission will be interrupted regardless of whether FR2NR succeeds.

### SUMMARY

Some exemplary embodiments are related to an apparatus of a user equipment (UE), the apparatus having processing circuitry configured to connect to a first network, perform a voice call fallback operation comprising disconnecting from the first network and performing a voice call on a second network, initiate a data service comprising uplink of data via the second network during the voice call, monitor data performance parameters associated with the second network and when the voice call is completed and there remains data to be uplinked for the data service, determine whether to remain on the second network or to return to the first network based at least on the data performance parameters.

Other exemplary embodiments are related to a processor configured to connect to the first network, perform a voice call fallback operation comprising disconnecting from the first network and performing a voice call on the second network, initiate a data service comprising uplink of data via the second network during the voice call, monitor data performance parameters associated with the second network and when the voice call is completed and there remains data to be uplinked for the data service, determine whether to remain on the second network or to return to the first network based at least on the data performance parameters.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows an exemplary timeline comparing fast return to NR (FR2NR) success and failure according to various exemplary embodiments.

FIG. 5 shows exemplary graphs comparing data speed vs. data interruption time length during FR2NR operations in three different usage scenarios according to various exemplary embodiments.

FIG. 6 shows a method for adaptive autonomous FR2NR operations according to various exemplary embodiments.

FIG. 7 shows exemplary flowcharts for downlink (DL) and uplink (UL) data performance evaluation in LTE according to various exemplary embodiments.

### DETAILED DESCRIPTION

The exemplary embodiments may be further understood with reference to the following description and the related appended drawings, wherein like elements are provided with the same reference numerals. The exemplary embodiments relate to evaluating whether FR2NR should occur, given the current LTE throughput and the current use case of the UE.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network where a fallback and fast return to the original network is utilized.

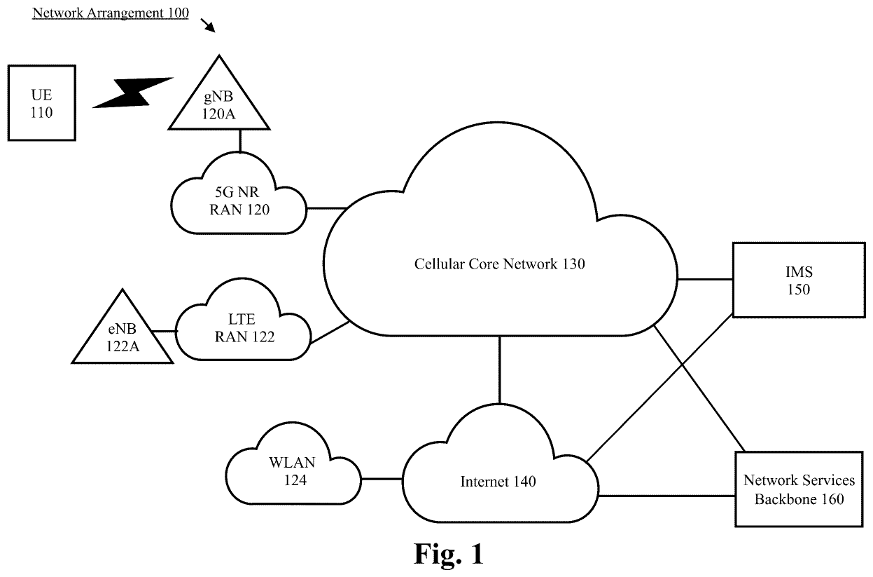

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120, an LTE RAN 122 and a wireless local area network (WLAN) 124. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120, the LTE RAN 122 and/or the WLAN 124. Therefore, the UE 110 may have a 5G NR chipset to communicate with the NR RAN 120, an LTE chipset to communicate with the LTE RAN 122 and an ISM chipset to communicate with the WLAN 124.

The 5G NR RAN 120 and the LTE RAN 122 may be portions of a cellular network that may be deployed by a network carrier (e.g., Verizon, AT&T, T-Mobile, etc.). The RANs 120, 122 may include cells or base stations that are configured to send and receive traffic from UEs that are equipped with the appropriate cellular chip set. In this example, the 5G NR RAN 120 includes the gNB 120A and the LTE RAN 122 includes the eNB 122A. However, reference to a gNB and an eNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.). The WLAN 124 may include any type of wireless local area network (WiFi, Hot Spot, IEEE 802.11x networks, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

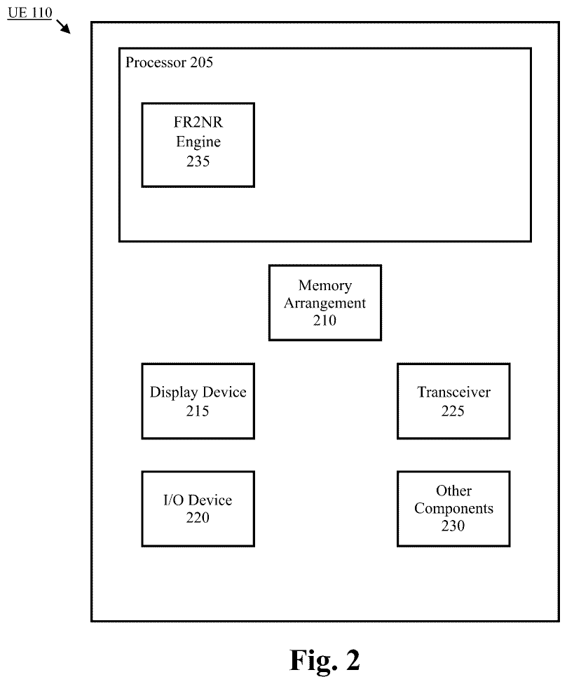

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a FR2NR engine 235 for performing operations including determining an UL and DL data performance of an LTE network for evaluation of whether to perform FR2NR. The exemplary operations will be described in greater detail below.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies). For example, the transceiver 225 may operate on the unlicensed spectrum when e.g., NR-U is configured. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

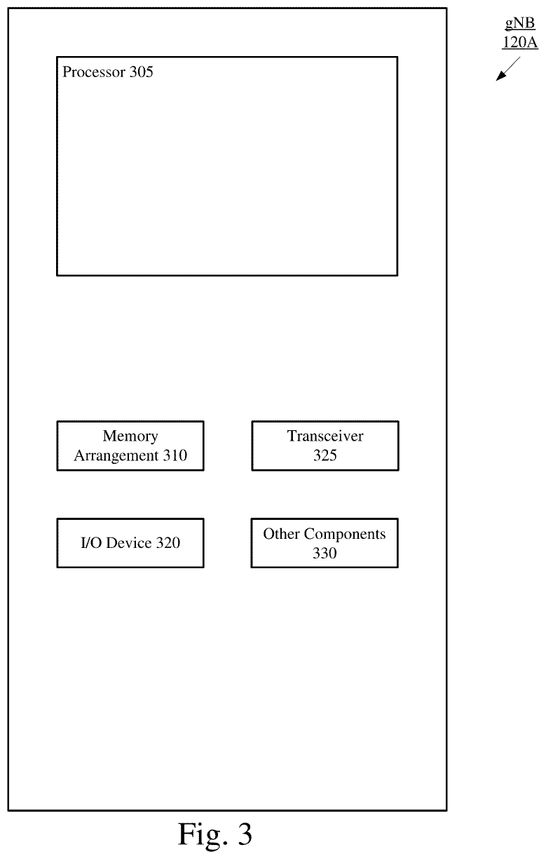

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. The engines may be an application (e.g., a program) executed by the processor 305. The functionality associated with the engines may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

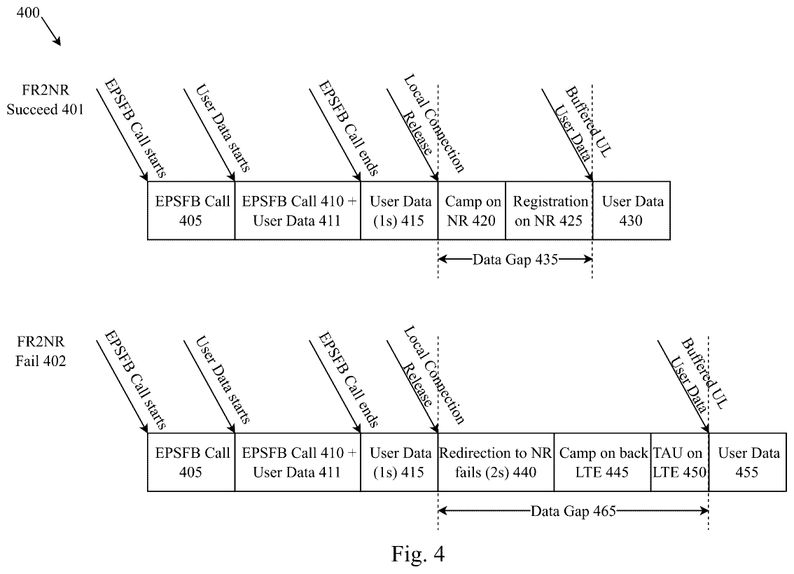

FIG. 4 shows an exemplary timeline comparing fast return to NR (FR2NR) success and failure according to various exemplary embodiments. Depicted in FIG. 4 are two timelines in which a FR2NR is attempted. FR2NR timeline 401 depicts a successful attempt for FR2NR and FR2NR timeline 402 depicts a failed attempt for FR2NR.

Operations 405, 410, and 415 proceed identically in both FR2NR timelines 401 and 402. At 405, the UE 110 begins an evolved packet system fallback (EPSFB) call while camped on the gNB 120A of the 5G NR-RAN 120. While 5G standards do support voice calls over 5G (VoNR), not all deployed networks and UEs currently support VoNR. Consequently, a fallback to a different network may be used for voice calls. One such solution is EPSFB, which relies upon the LTE-RAN 122 (e.g., a 4G network) to complete the voice call (e.g., VoLTE).

At 405, the UE 110 is connected to the 5G NR-RAN 120 via a gNB 110A and initiates a voice call. The voice call is placed on the LTE-RAN 122 via the eNB 122A. At 410, user data 411 may be triggered to be sent via the LTE connection from the UE 110 to the eNB 122A while the EPSFB call is ongoing. At 415, the EPSFB call ends, while the user data 411 continues to be transmitted in the uplink to the eNB 122A. This uplink transmission of user data 411 continues for one second in the exemplary timeline, but this length of time is only exemplary and may be adjusted. Those of skill in the art will understand that it is often desirable to return to NR from LTE as quickly as possible.

In the successful FR2NR timeline 401, at 420 the UE 110 camps on the 5G NR-RAN 120 via the gNB 120A and at 425, the UE 110 registers with the 5G NR-RAN 120. The camping time 420 and registration time 425 may be added together to provide a data gap time 435. The data gap time 435 may be understood to be a period of time during which the user data 411 is no longer being transmitted to either the LTE-RAN 122 via the eNB 122A or the 5G NR-RAN 120 via the qNB 120A. Once the UE 110 successfully registers with the 5G NR-RAN 120, the UE 110 may continue with transmitting the uplink data 430 via the gNB 120A.

In the failure FR2NR timeline 402, at 440 the UE 110 fails to redirect back to the previously connected 5G NR-RAN 120. This redirection failure time continues for an exemplary 2 seconds, but this time period is only for illustrative purposes. At 445, the UE 110 camps back on the LTE-RAN 122 via the eNB 122A.

In some situations, the UE 110 may have changed location when unsuccessfully attempting to redirect to the NR-RAN 120 and then camping back on the LTE-RAN 122. If the tracking area has changed during this time, the UE 110 may perform a tracking area update (TAU) 450 on LTE-RAN 122 before user data 411 can continue to be transmitted via the uplink. The TAU 450 takes further time and adds to the data gap 465. Data gap 465 represents the sum of the redirection to NR failure time 440, the camping back on LTE time 445, and the TAU on LTE time 450. Data gap 465 may be understood to be larger than data gap 435. At 455 data transmission of user data 411 begins again on the LTE-RAN 122 due to the failure to reconnect to the 5G NR-RAN 120.

The FR2NR timelines 401 and 402 are provided to illustrate the time lost to data gaps 435 and 465. In both timelines, there are periods of time in which the user data 411 is not being transmitted via the uplink to either the NR-RAN 120 or the LTE-RAN 122 that may result in a poor user experience. Minimizing this data gap may enhance the user experience.

The data gap during FN2NR may include packet loss, which is buffered in a layer 2 (L2) buffer and inter-radio access technology (IRAT) delay (e.g., data gap 435). Should IRAT reselection fail, this time will be even longer still, as demonstrated by data gap 435 compared to data gap 465.

FR2NR may be valuable for high throughput data services because throughput is substantially greater on NR than LTE. In these high throughput scenarios, the data gap during FN2NR may be effectively ignored because it is insubstantial compared to the time saved by switching back to NR from LTE.

However, certain scenarios do not require FR2NR. TWO such examples are for small data burst services (SDBS) (e.g., email) or real-time online games (RTOG) which are sensitive to data interruption. Should these services not require a high throughput and LTE can provide enough throughput to ensure adequate data performance, there is no need for FR2NR.

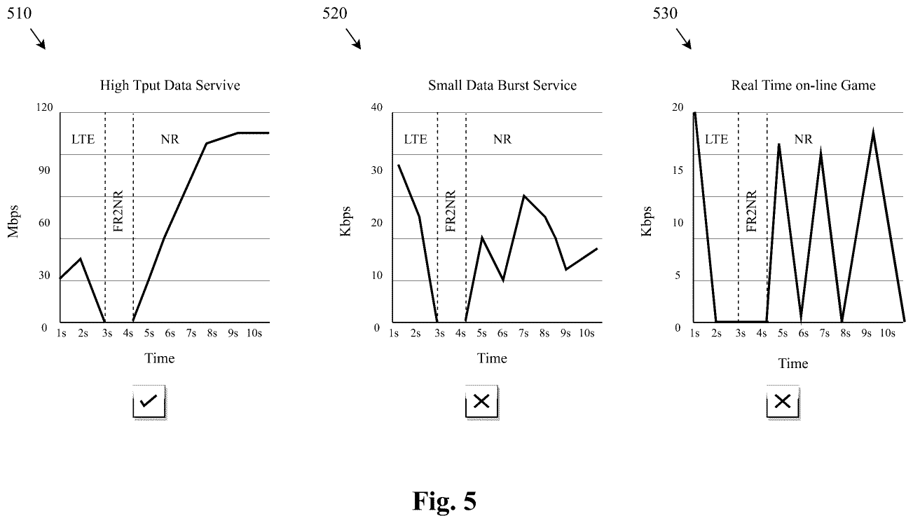

FIG. 5 shows exemplary graphs comparing data speed vs. data interruption time length during FR2NR operations in three different usage scenarios according to various exemplary embodiments. In 510, a high throughput data service is depicted. The UE leaves LTE operating at approximately 40 Mbps in the uplink/downlink for NR operating at approximately 100 Mbps in the uplink/downlink. In this scenario, it is desirable to use FR2NR. The total data transmitted may be understood as the area beneath the curve in 510, which increases dramatically after FR2NR from the higher throughput of NR compared to LTE.

In 520, a small data burst service is depicted. In contrast to 510, these data bursts are small and the area beneath the curve is comparable to LTE before and after FR2NR. Consequently, there is no need for FR2NR in this scenario.

In 530, a real time online game is depicted. In contrast to 510, the real time online game data transmissions and the area beneath the curve is comparable to LTE before and after FR2NR. In addition, real time online gaming is very sensitive to data gaps and a long data delay may lead to a loss of connection to the gaming server. Consequently, in this scenario, it may be better to remain on LTE until the data transfer is complete rather than immediately performing FR2NR.

Those of skill in the art will understand that the above described scenarios are only exemplary and there may be other scenarios where FR2NR may not be an appropriate solution. Thus, the exemplary embodiments are directed to determining when FR2NR is appropriate given data performance in LTE and NR cell availability to ensure satisfactory data transmission.

The exemplary embodiments are directed to an adaptive autonomous FR2NR. In situations in which there is data outgoing after an EPSFB call ends on LTE, given no network direction, it is desirable to not perform blind autonomous FR2NR. Instead, the exemplary embodiments are directed to adaptively triggering autonomous FR2NR based on data performance in LTE and NR cell availability.

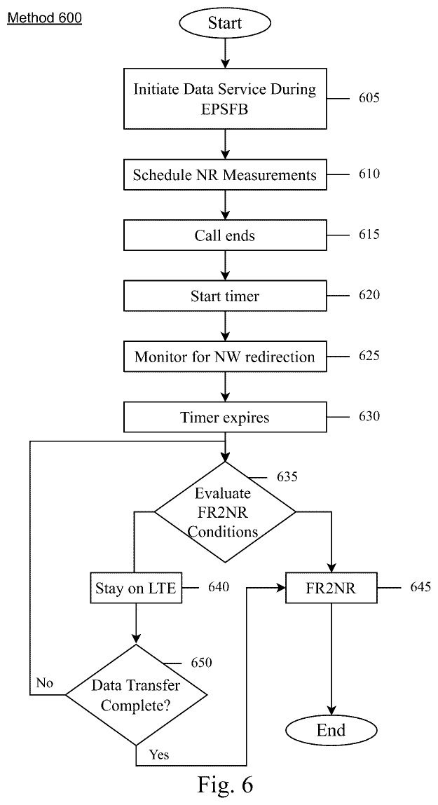

FIG. 6 shows a method 600 for adaptive autonomous FR2NR operations according to various exemplary embodiments. The method 600 may be performed by the UE 110. The UE 110 may be initially connected to the 5G NR-RAN 120 via the gNB 120A. The user may initiate or receive a voice call while camped on the gNB 120A but network conditions/permissions and/or the UE 110 itself may not support VoNR. Instead, the UE 110. disconnects from the 5G NR-RAN 120 and connects to LTE-RAN 122 to perform the call (as an EPSFB call). The method of 600 may be understood to occur after the UE 110 has begun the EPSFB call.

At 605, a data service is triggered during an EPSFB call. Some exemplary data services include a small data burst service (such as an outgoing email) or a real time online game. These data services are only exemplary, however, and one of skill in the art will understand that any variety of data services may be triggered during the EPSFB call.

Once the data service is triggered, the UE 110 may monitor Key Performance Indicators (KPIs) for the LTE data transmissions for use in a statistical calculation. The statistical calculation will be discussed in further detail below.

At 610, the UE 110 autonomously schedules measurements related to the 5G NR-RAN 120. These measurements may be used to determine the availability of the 5G NR-RAN 120 when data is triggered during an ongoing IMS voice call if there is no NR measurement scheduled by the network. As will be described in greater detail below, one of the conditions for triggering or not triggering FR2NR may be the availability of the 5G NR-RAN 120. If the UE 110 has not been scheduled to perform measurements related to the 5G NR-RAN 120, the UE 110 cannot evaluate this condition. Thus, in 610, the UE 110 will autonomously schedule NR measurements to evaluate the condition.

In some exemplary, the UE 110 may include a dual-receiver capability (e.g., multi-SIM (MSIM) devices) allowing the UE 110 to perform the NR measurements without tuning away from the LTE-RAN 122 during the data transmission. In other exemplary embodiments, the UE 110 may not include a dual-receiver capability and may tune away to perform the NR measurements. The UE 110 may perform these measurements using storage list search (SLS) frequencies, e.g., 5G NR frequencies the UE 110 used prior to disconnecting from the 5G NR-RAN 120.

At 615, the EPSFB call ends while the data transmission on the LTE-RAN 122 continues. At 620, the UE 110 may begin a T FR2NR timer and in 625, monitor for redirection by the NR network. During the monitoring, if the UE 110 receives a network connection release, the UE 110 will follow the indication, stop the timer and go directly to the FR2NR procedure. Otherwise, the UE 110 will wait until the timer expires as will be described below. The monitoring may include performing the scheduled NR measurements and collecting information about the LTE data transmissions. The timer allows the UE 110 to collect the information to make the determination as to whether FR2NR should be performed. At 630, the timer expires. Any suitable length of time may be selected for the timer.

At 635, the UE 110 evaluates whether to perform FR2NR operations. This evaluation may depend on a variety of factors including, the availability of the 5G NR-RAN 120, the data service and data transmission requirements of the data service (e.g., whether the LTE-RAN 122 data performance can satisfy the current service requirements for the data service), etc. As discussed with reference to FIG. 5, certain data services may not need to transition back to NR immediately. On the other hand, the 5G NR-RAN 120 may be available and LTE may not be able to meet the data transmission requirements of the data service, thus, a transition back to NR using FR2NR may be appropriate.

The following provides exemplary manners of evaluating the performance of the LTE-RAN 122 to determine whether to perform FR2NR operations, e.g., whether the LTE data service is satisfactory to continue the current data service without performing FR2NR. The data service performance may be determined for the uplink (UL) or the downlink (DL).

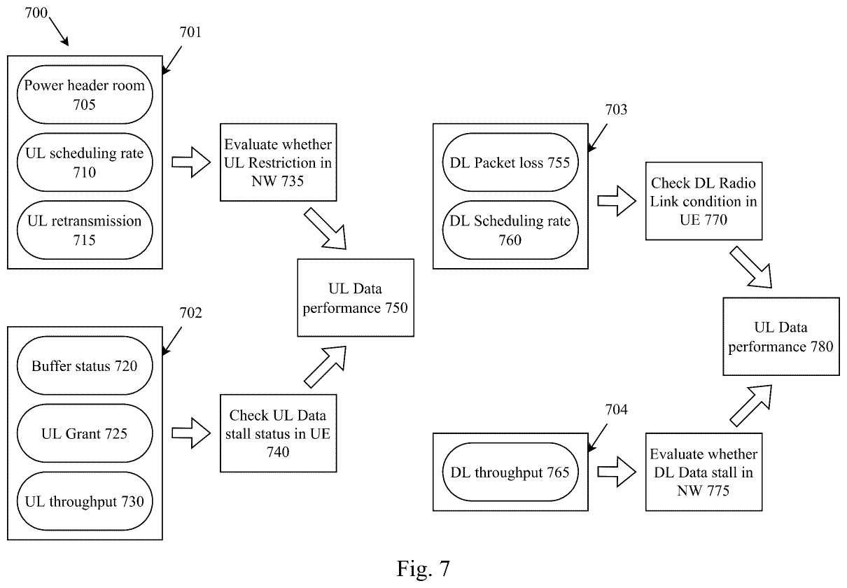

FIG. 7 shows exemplary flowcharts for downlink (DL) and uplink (UL) data performance evaluation in LTE according to various exemplary embodiments. The box 701 shows three exemplary parameters that may be used in the performance evaluation, power headroom (PHR) 705, UL Scheduling Rate 710 and UL retransmissions 715. As described above, the performance evaluation may be based on a statistical analysis of the measured parameters. Those skilled in the art will understand that there are various manners of statistically combining two or more parameters for the purposes of determining information from the parameters.

In some exemplary embodiments, the value of these parameters 705-715 may be compared to a threshold, e.g., PHR>TH_{PHR}, UL Scheduling Rate<TH_{scheduling_ul}, UL Retransmission>TH_{retrans_ul}. In other exemplary embodiments, the value of these parameters 705-715 may be combined into a ratio for the performance evaluation. The ratio may be determined based on the absolute values or based on the comparisons to the thresholds described above. The parameters/ratios shown in box 701 may be used by the UE 110 in 735 to evaluate whether there is an UL restriction in the LTE-RAN 122.

It should be understood that the parameters 705-715 are only exemplary and that more, less or different parameters may be used to determine the data performance. Furthermore, the above examples provided different manners of evaluating the parameters, e.g., absolute values, ratios. It should be understood that the manner of evaluating the parameters is also exemplary and there may be various manners of combining and adjusting thresholds and ratios according to operational needs to make the determination of the UL restriction.

The box 702 shows additional parameters that may be used by the UE 110 in determining the uplink data performance on LTE. It should be understood that the parameters in the box 702 may be used with those described in the box 701. The parameters include a buffer status 720, a UL grant pattern received from the network 725, and a UL throughput 730. Again, these parameters and/or ratios thereof may be combined in various manners in 740 to check the UL data stall status 740.

The evaluation of the UL restriction in the network 735 and the UL data stall status 740 may be used by the UE 110 to determine a UL data performance 750. This UL data performance may then be used by the UE 110 to determine whether to remain on the LTE-RAN 122 for the data service or to implement FR2NR.

Similar to the UL evaluation, the UE 110 may also perform a DL evaluation for the LTE-RAN 122. The box 703 shows some exemplary parameters that may be used by the UE 110 for DL performance evaluation. These parameters include a DL packet loss 755 and a DL scheduling rate 760. These parameters 755-760 may be used by the UE 110 to check the DL radio link condition 770. The box 704 contains a single additional factor for DL data performance evaluation, a DL throughput 765. The DL throughput 765 may be used by the UE 110 to determine whether there will be a DL data stall 775 on the DL connection with the LTE-RAN 122. The stall evaluation 775 and DL radio link connection check 770 may be used together to determine a DL data performance 780. Again, the manner of evaluating and combining the individual parameters for the purposes of evaluating the DL link may be similar to the examples described above.

The following provides an example of parameters and parameter values that indicate bad data performance in one exemplary scenario. It should be understood that these parameters and values are only exemplary and are provided as an example of comparing parameters and/or performing a statistical analysis on the parameters for the purposes of determining whether the LTE connection satisfies the data requirements of the data service. In this example, the UL parameters include the PHR=0 indicating the UE has received the maximum Tx power in the uplink and there is no room for the network to increase its allocated UL Physical Resource Block (PRB). The UL Scheduling Rate=0.36% which may be considered a low scheduling rate that indicates the network is busy. The buffer status report (BSR)=63 indicating the UE has accumulated the maximum UL data to be sent. The UL PRB=33 (for UL Grant) and the UL Throughput=0.055 Mbps which may be considered to be a low throughput indicating the UE is not receiving enough resources from the network. The DL parameters include a DL Scheduling Rate=1.29% and DL throughput=0.061 Mbps. These parameters indicate a low DL scheduling rate also indicating the network is busy and a low DL throughput indicating the UE is not receiving enough resources from the network. Thus, the above examples show a scenario where it may be considered that the LTE data performance is unsatisfactory and FR2NR should be used if the NR network is available.

Returning to FIG. 6, if the UL data performance 750 and DL data performance 780 are adequate to support the current data service, the UE 110 may stay camped 640 on the LTE-RAN 122 for the duration of the current data service in order to avoid the data gaps depicted in 520 and 530 which negatively impact the user experience.

In addition to performing LTE performance evaluations, in 635, the UE 110 may also check NR cell availability to determine if FR2NR is appropriate. NR cell availability may be checked using the NR measurement results described above that are obtained while the UE 110 is still connected to the LTE-RAN 122. In some exemplary embodiments, the UE 110 may be a multi-subscriber identification module (SIM) UE. In these exemplary embodiments, it may be possible to obtain NR cell information from a different SIM on the same UE so long as both SIMs are for the same cellular provider.

When it is determined to remain connected 640 to the LTE-RAN 122, the UE 110 then determines, in 650, whether the data transfer is complete. If the data transfer is not complete in 650 the UE 110 continues to evaluate 635 the data performance of the LTE-RAN 122 (and the availability of the 5G NR-RAN 120) to make sure the UE 110 should remain connected to the LTE-RAN 122. If the data transfer is complete in 650, the autonomous FR2NR is triggered in 645 to return the UE 110 to the 5G NR-RAN 120.

Returning to 635, if the evaluation of the data performance for the LTE-RAN 122 indicates that the connection is not adequate for the data service and the 5G NR-RAN 120 is available, the UE 110 performs the FR2NR to 5G NR-RAN 120 in 645 to ensure the throughput and to enhance the user experience for the data service.

### EXAMPLES

In a first example, a method performed by a user equipment (UE) configured, comprising connecting to a first network, performing a voice call fallback operation comprising disconnecting from the first network and performing a voice call on a second network, initiating a data service comprising uplink of data via the second network during the voice call, monitoring data performance parameters associated with the second network and when the voice call is completed and there remains data to be uplinked for the data service, determining whether to remain on the second network or to return to the first network based at least on the data performance parameters.

In a second example, the method of the first example, wherein the first network comprises a New Radio (NR) network, the second network comprises a Long Term Evolution (LTE) network and the voice call fallback operation is an Evolved Packet System Fallback (EPSFB) call.

In a third example, the method of the first example, further comprising performing measurements on the first network while the UE is connected to the second network.

In a fourth example, the method of the third example, further comprising determining whether the first network is available based on the measurements on the first network, wherein the determining whether to remain on the second network or to return to the first network is further based on an availability of the first network.

In a fifth example, the method of the third example, wherein the measurements on the first network comprise measurements on one or more frequencies in a storage list search (SLS) of the UE.

In a sixth example, the method of the first example, further comprising initiating a timer when the voice call is completed, wherein returning to the first network is not performed until the timer expires.

In a seventh example, the method of the first example, further comprising determining the data to be uplinked for the data service is complete or a connection release is received from the second network and returning to the first network.

In an eighth example, the method of the first example, wherein monitoring data performance parameters associated with the second network comprises monitoring parameters in an uplink (UL) or a downlink (DL).

In a ninth example, the method of the eighth example, wherein the parameters in the UL comprise a power headroom, a UL scheduling rate, a number of UL retransmissions, a UL buffer status, a UL grant pattern or a UL throughput.

In a tenth example, the method of the eighth example, wherein the parameters in the DL comprise a DL packet loss, a DL scheduling rate or a DL throughput.

In an eleventh example, the method of the eighth example, wherein the monitoring data performance parameters associated with the second network comprises performing a statistical analysis on the measured parameters.

In a twelfth example, a processor configured to perform any of the methods of the first through eleventh examples.

In a thirteenth example, a user equipment (UE) comprising a transceiver configured to communicate with a network and a processor communicatively coupled to the transceiver and configured to perform any of the methods of the first through eleventh examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configured to:
connect to a first network;
perform a voice call fallback operation comprising disconnecting from the first network and performing a voice call on a second network;
initiate a data service comprising uplink of data via the second network during the voice call;
monitor data performance parameters associated with the second network; and
when the voice call is completed and there remains data to be uplinked for the data service, determine whether to remain on the second network or to return to the first network based at least on the data performance parameters.

2. The apparatus of claim 1, wherein the first network comprises a New Radio (NR) network, the second network comprises a Long Term Evolution (LTE) network and the voice call fallback operation is an Evolved Packet System Fallback (EPSFB) call.

3. The apparatus of claim 1, wherein the processing circuitry is further configured to:
perform measurements on the first network while the UE is connected to the second network.

4. The apparatus of claim 3, wherein the processing circuitry is further configured to:
determine whether the first network is available based on the measurements on the first network, wherein the determining whether to remain on the second network or to return to the first network is further based on an availability of the first network.

5. The apparatus of claim 3, wherein the measurements on the first network comprise measurements on one or more frequencies in a storage list search (SLS) of the UE.

6. The apparatus of claim 1, wherein the processing circuitry is further configured to:
initiate a timer when the voice call is completed, wherein returning to the first network is not performed until the timer expires.

7. The apparatus of claim 1, wherein the processing circuitry is further configured to:
determine the data to be uplinked for the data service is complete or a connection release is received from the second network; and
return to the first network.

8. The apparatus of claim 1, wherein monitoring data performance parameters associated with the second network comprises monitoring parameters in an uplink (UL) or a downlink (DL).

9. The apparatus of claim 8, wherein the parameters in the UL comprise a power headroom, a UL scheduling rate, a number of UL retransmissions, a UL buffer status, a UL grant pattern or a UL throughput.

10. The apparatus of claim 8, wherein the parameters in the DL comprise a DL packet loss, a DL scheduling rate or a DL throughput.

11. The apparatus of claim 8, wherein the monitoring data performance parameters associated with the second network comprises performing a statistical analysis on the measured parameters.

12. A processor configured to:
connect to the first network;
perform a voice call fallback operation comprising disconnecting from the first network and performing a voice call on the second network;
initiate a data service comprising uplink of data via the second network during the voice call;
monitor data performance parameters associated with the second network; and
when the voice call is completed and there remains data to be uplinked for the data service, determine whether to remain on the second network or to return to the first network based at least on the data performance parameters.

13. The processor of claim 12, wherein the first network comprises a New Radio (NR) network, the second network comprises a Long Term Evolution (LTE) network and the voice call fallback operation is an Evolved Packet System Fallback (EPSFB) call.

14. The processor of claim 12, further configured to:
perform measurements on the first network while the UE is connected to the second network.

15. The processor of claim 14, further configured to:
determine whether the first network is available based on the measurements on the first network, wherein the determining whether to remain on the second network or to return to the first network is further based on an availability of the first network.

16. The processor of claim 14, wherein the measurements on the first network comprise measurements on one or more frequencies in a storage list search (SLS) of the UE.

17. The processor of claim 12, further configured to:
initiate a timer when the voice call is completed, wherein returning to the first network is not performed until the timer expires.

18. The processor of claim 12, further configured to:
determine the data to be uplinked for the data service is complete or a connection release is received from the second network; and
return to the first network.

19. The processor of claim 12, wherein monitoring data performance parameters associated with the second network comprises monitoring parameters in an uplink (UL) or a downlink (DL).

20. The processor of claim 19, wherein the parameters in the UL comprise a power headroom, a UL scheduling rate, a number of UL retransmissions, a UL buffer status, a UL grant pattern or a UL throughput.
